(19) United States
(12) Patent Application Publication
(10) Pub. No.: US 2007/0001600 A1
(43) Pub. Date: Jan. 4, 2007

(54) Plasma display panel

(75) Inventor: Kyung Wha Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/478,138

(22) Filed: Jun. 30, 2006

(30) Foreign Application Priority Data
Jul. 1, 2005 (KR) 10-2005-0059430

(51) Int. Cl. H01J 17/00

(52) U.S. Cl. 313/517

(57) ABSTRACT

A plasma display panel is disclosed. The plasma display panel includes a substrate, a first electrode formed on the substrate in a first oblique line direction of a discharge cell, and a second electrode formed on the substrate in a second oblique line direction.

### CROSS-REFERENCE TO RELATED APPLICATION

This non-provisional application claims priority under 35 U.S.C § 119(a) on Patent Application No. 10-2005-0059430 filed in Korea on Jul. 01, 2005 the entire contents of which are hereby incorporated by reference.

### BACKGROUND OF THE INVENTION

1. Field of the Invention

This document relates to a plasma display panel.

2. Description of the Background Art

A plasma display panel (PDP) displays an image and includes a plurality of discharge cells formed by a barrier rib between a front panel and a rear panel. Each of the discharge cells is filled with a main discharge gas such as, Ne, He and mixture (Ne+He) thereof, and an inert gas containing a small amount of xenon. These discharge cells form one pixel. For example, a red (R) discharge cell, a green (R) discharge cell, and a blue (B) discharge cell form one pixel.

When the PDP is discharged by a high frequency voltage, the inert gas generates vacuum ultraviolet (UV) rays and emits light from a phosphor formed between the barrier ribs so that the image is displayed on the plasma display panel.

### SUMMARY OF THE INVENTION

Embodiments of the present invention provide a plasma display panel that can improve luminance and discharge effect during a plasma discharge by forming a plurality of electrodes of the PDP in an oblique line direction and reduce manufacturing cost by forming the electrodes formed in the PDP as bus electrodes.

According to an aspect, there is provided a plasma display panel, which includes a substrate; a first electrode formed on the substrate in a first oblique line direction of a discharge cell, and a second electrode formed on the substrate in a second oblique line direction.

According to another aspect, there is provided a plasma display panel, which includes a substrate; a first electrode formed on the substrate in a first oblique line direction of a discharge cell; a second electrode formed on the substrate in a second oblique line direction of the discharge cell, and a center electrode formed between the first electrode and the second electrode.

According to still another aspect, there is provided a plasma display panel, which includes a substrate; a first electrode formed on the substrate in a first oblique line direction of a discharge cell; a second electrode formed on the substrate in a second oblique line direction of the discharge cell; a first center electrode formed closer to the first electrode than the second electrode; and a second center electrode formed closer to the second electrode than the first electrode.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates the structure of a PDP according to an exemplary embodiment of the present invention;

FIG. 2 illustrates first and second electrodes of each discharge cell in the PDP as shown in FIG. 1;

FIG. 3 illustrates an instance where a plurality of projection electrodes are formed on the first and second as shown in FIG. 2;

FIG. 4 illustrates bisymmetry of each of the first and second electrodes in one discharge cell as shown in FIG. 3;

FIG. 5 illustrates an instance where a center electrode is formed between the first electrode and the second electrode;

FIG. 6 illustrates an instance where a plurality of projection electrodes are formed on at least one of the first electrode, the second electrode or the center electrodes;

FIG. 7 illustrates bisymmetry of each of the first, second and center electrodes as shown in FIG. 6;

FIG. 8 illustrates an instance where two center electrodes are formed between the first electrode and the second electrode;

FIG. 9 illustrates an instance where at least one of the first electrode or the second electrodes is formed in a direction perpendicular to an address electrode in each discharge cell;

FIG. 10 illustrates an instance where a plurality of projection electrodes are formed on at least one of the first electrode, the second electrode, the first center electrode or the second center electrode; and

FIG. 11 illustrates an instance where the first and second electrodes and the first and second center electrodes are respectively left/right and up/down symmetry about the center of one discharge cell.

### DETAILED DESCRIPTION OF THE PREFERRED EMBODIMENTS

A plasma display panel according to embodiments of the present invention comprises a substrate, a first electrode formed on the substrate in a first oblique line direction of a discharge cell, and a second electrode formed on the substrate in a second oblique line direction.

The first electrode may comprise either a scan electrode or a sustain electrode, and the second electrode may comprise either the scan electrode where the first electrode comprises the sustain electrode, or the sustain electrode where the first electrode comprises the scan electrode.

At least one of the first electrode or the second electrode may comprise a bus electrode.

At least one of the first electrode or the second electrode may comprise a plurality of projection electrodes.

The plurality of projection electrodes of the first electrode may be projected toward the second electrode direction, and the plurality of projection electrodes of the second electrode direction is projected toward the first electrode.

The first oblique line direction may be approximately the same as the second oblique line direction.

The first and second electrodes may be located within the discharge cell such that the first and second electrodes are bilaterally symmetrical to each other about the center of the discharge cell.

A plasma display panel according to the embodiments of the present invention comprises substrate, a first electrode formed on the substrate in a first oblique line direction of a discharge cell, a second electrode formed on the substrate in a second oblique line direction of the discharge cell, and a center electrode formed between the first electrode and the second electrode.

The first electrode and the second electrode comprise either a scan electrode or a sustain electrode, and the center electrode comprises either the scan electrode where the first electrode and the second electrode comprise the sustain electrode, or the sustain electrode where the first electrode and the second electrode comprise the scan electrode.

At least one of the first electrode, the second electrode or the center electrode may comprise a bus electrode.

At least one of the first electrode, the second electrode or the center electrode may comprise a plurality of projection electrodes.

The plurality of projection electrodes of at least one of the first electrode or the second electrode may be projected toward the center electrode of the discharge cell.

The plurality of projection electrodes of the center electrode may be projected toward at least one of the first electrode or the second electrode.

The first oblique line direction may be approximately the same as the second oblique line direction.

The first, second and center electrodes may be located within the discharge cell such that the first, second and center electrodes may be bilaterally symmetrical to each other about the center of the discharge cell.

A plasma display panel according to the embodiments of the present invention comprises a substrate, a first electrode formed on the substrate in a first oblique line direction of a discharge cell, a second electrode formed on the substrate in a second oblique line direction of the discharge cell, a first center electrode formed closer to the first electrode than the second electrode, and a second center electrode formed closer to the second electrode than the first electrode.

At least one of the first electrode or the second electrode may comprise an electrode formed in a direction perpendicular to an address electrode.

The electrode formed in the direction perpendicular to the address electrode may be in parallel with transverse barrier ribs between the discharge cells.

At least one of the first electrode, the second electrode, the first center electrode or the second center electrode may comprise a bus electrode.

At least one of the first electrode, the second electrode, the first center electrode or the second center electrode may comprise a plurality of projection electrodes.

The plurality of projection electrodes of at least one of the first electrode or the second electrodes may be projected toward the center electrode.

The plurality of projection electrodes of the first and second center electrodes may be projected toward at least one of the first electrode or the second electrode.

The first oblique line direction may be different from the second oblique direction.

The first and second electrodes and the first and second center electrodes may be left-right or up-down symmetry about the center of each discharge cell.

The first electrode and the second electrode may comprise either a scan electrode or a sustain electrode, and the first center electrode and the second center electrode may comprise either the scan electrode where the first electrode and the second electrode comprise the sustain electrode, or the sustain electrode where the first electrode and the second electrode comprise the scan electrode.

The shortest distance between the scan electrode and the sustain electrode may range from 30 μm to 70 μm.

The first electrode and the second center electrode may comprise either a scan electrode or a sustain electrode, and the first center electrode and the second electrode may comprise either the scan electrode where the first electrode and the second center electrode comprise the sustain electrode, or the sustain electrode where the first electrode and the second center electrode comprise the scan electrode.

The shortest distance between the scan electrode and the sustain electrode may range from 30 μm to 70 μm.

A section width of at least one of the first electrode, the second electrode, the first center electrode or the second center electrode may range from 20 μm to 60 μm.

Hereafter, the plasma display panel according to the preferred embodiments of the present invention will be explained in detail with the accompanying drawings.

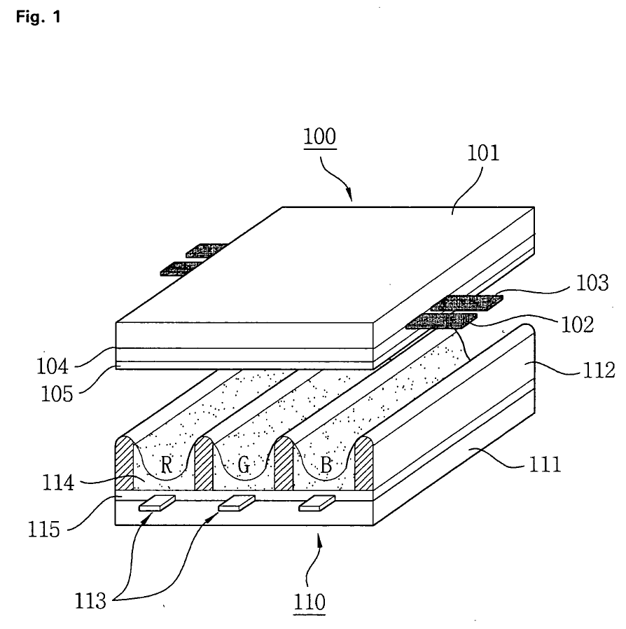

FIG. 1 illustrates the structure of a PDP according to an exemplary embodiment of the present invention.

As illustrated in FIG. 1, the plasma display panel comprises a front panel 100 and a rear panel 110 which are coupled in parallel to oppose to each other at a given distance therebetween. The front panel 100 comprises a front substrate 101 which is a display surface. The rear panel 110 comprises a rear substrate 111 constituting a rear surface. A first electrode 102 and a second electrodes 103 are formed on the front substrate 101, on which an image is displayed. An address electrode 113 is arranged on the rear substrate 111 to intersect first electrode 102 and a second electrodes 103.

The front panel 100 may also include a bus electrode having the first and second electrodes 102 and 103 formed of metal materials, so that the first and second electrodes 102 and 103 are discharged each other in each discharge cell 200 and light-emitting of the discharge cell 200 is maintained.

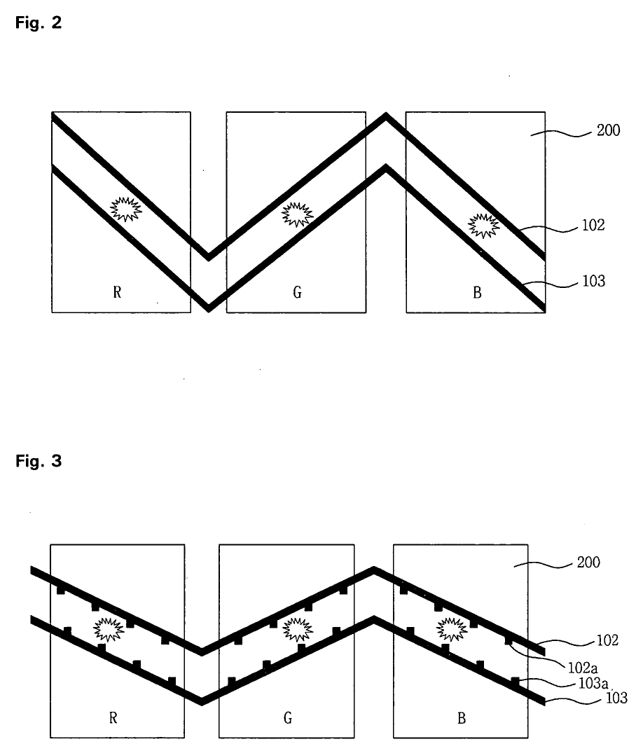

The first and second electrodes 102 and 103 are formed in each of the discharge cells in an oblique line direction. This will be explained in detail with reference to FIG. 2.

Although in FIG. 1 is shown that the first and second electrodes 102 and 103 are configured of the bus electrode formed of metal materials, the first and second electrodes 102 and 103 may be configured of a transparent electrode formed of transparent indium tin oxide (ITO) and a bus electrode formed of metal materials, the transparent electrode and bus electrode being paired with each other.

Additionally, the first and second electrodes 102 and 103 may be covered with one or more top dielectric layers 104 for restricting a discharge current and insulating between the paired electrodes, and may form a protective layer 105, on which MgO is deposited on an upper surface of the top dielectric layers 104, in order to facilitate a discharge condition.

In the rear panel 110, one or more stripe type (or well type) barrier ribs 112 for forming a plurality of discharge spaces (i.e., discharge cells) may be arranged in parallel with each other. The plurality of address electrodes 113 perform the address discharge to generate vacuum ultraviolet (UV) rays, and may be arranged in parallel with the barrier ribs 212.

An upper surface of the rear panel 210 is coated with R, G, and B phosphors 114 that emit visible rays to display an image during address discharge. A lower dielectric layer 215 may be formed between the address electrodes 113 and the phosphors 114 to protect the address electrodes 113.

Only one example of the PDP applicable to the present invention is shown and explained in FIG. 1, but is not limited thereto.

For example, although the upper dielectric layer 104 with a constant thickness is shown in FIG. 1, a thickness and a dielectric constant of the upper dielectric layer 104 may be different from each area. Additionally, although the barrier ribs 112 with a constant distance is shown in FIG. 1, a distance between the barrier ribs of a B discharge cell may be wider.

Further, side surfaces of the barrier ribs 112 are formed with a concave-convex shape and coated with the phosphors 114, thereby allowing luminance of the image displayed by the PDP to be improved.

Further, in order to improve exhaust characteristics during manufacturing processes of the PDP, a tunnel may be formed in side surfaces of the barrier ribs.

In the PDP, the first and second electrodes 102 and 103 formed on the front substrate will be explained in detail with reference to FIG. 2.

FIG. 2 illustrates first and second electrodes of each discharge cell in the PDP as shown in FIG. 1.

Referring to FIG. 2, when the PDP shown in FIG. 1 is seen from its front side, the first electrode 102 is formed on the front substrate 101 in a first oblique line direction of each of the discharge cells 200, and the second electrode 103 is formed on the front substrate 101 in a second oblique line direction of each of the discharge cells 200.

The first oblique line direction may be approximately the same as the second oblique line direction, as shown in FIG. 2.

As a result thereof, a distance between the first electrode 102 and the second electrode 103 may be constantly maintained, so that a discharge in each of the discharge cells 200 is uniformly produced by a constant discharge gap between the first electrode 102 and the second electrode 103.

As such, the first and second electrodes 102 and 103 are formed in the oblique line directions of the discharge cells 200 to form a wide discharge area in one discharge cell 200, thereby improving luminance of the image realized by the PDP.

For example, if one scan electrode and one sustain electrode are formed in and in parallel with each of the discharge cell 200, the discharge gap is formed in parallel with the discharge cells 200. Accordingly, light-emitting of the phosphors is produced from the discharge gap on the center of each of the discharge cell 200. in other words, the discharge area is mainly formed on the center of each of the discharge cells 200.

However, if the first and second electrodes 102 and 103 are formed in the oblique line directions of each of the discharge cells 220, as shown in FIG. 2, the discharge gap and the wide discharge area are respectively formed in the oblique line directions of each of the discharge cells 220. Thus, the luminance may be improved more and more.

In one discharge cell, one of the scan electrode and the sustain electrode may be the first electrode 102, and the other may be the second electrode 103.

In addition, at least one of the first electrode 102, the second electrode 103 or the center electrode 104 may be configured of only bus electrode. Accordingly, it is not necessary to use the transparent electrode, thereby allowing manufacturing cost of hardware to be reduced. Further, since a process for forming the transparent electrode is not necessary during the manufacturing processes, a production yield is improved.

Until now, the first and second electrodes 102 and 103 are only explained. However, the first and second electrodes 102 and 103 including a plurality of projection electrodes may be also formed. This will be explained with reference to FIG. 3.

FIG. 3 illustrates an instance where a plurality of projection electrodes are formed on the first and second as shown in FIG. 2.

Referring to FIG. 3, at least one of the first electrode or the second electrode 102 and 103 may include the plurality of projection electrodes.

The plurality of projection electrodes 102a included in the first electrode 102 may be projected toward the second electrode 103, and the plurality of projection electrodes 103a may be projected toward the first electrode 102.

This makes it easy to produce initial discharge, by projecting the plurality of projection electrodes 102a and 103a toward the first and second electrodes 102 and 103 that are discharged, because a discharge gap is formed between the first electrode 102 and the second electrode 103.

On physical properties of a conductor, charges are largely formed in both end parts of the conductor compared with a body part thereof. Accordingly, since wall charges are formed largely at the projection electrodes in each of the discharge cells 200, the initial discharge is more sensitive and easier to produce.

Even when a voltage necessary for discharging the first and second electrodes 102 and 103 is slightly changed by external effects such as noise, the discharge may be stably produced by including the projection electrodes in the first and second electrodes 102 and 103.

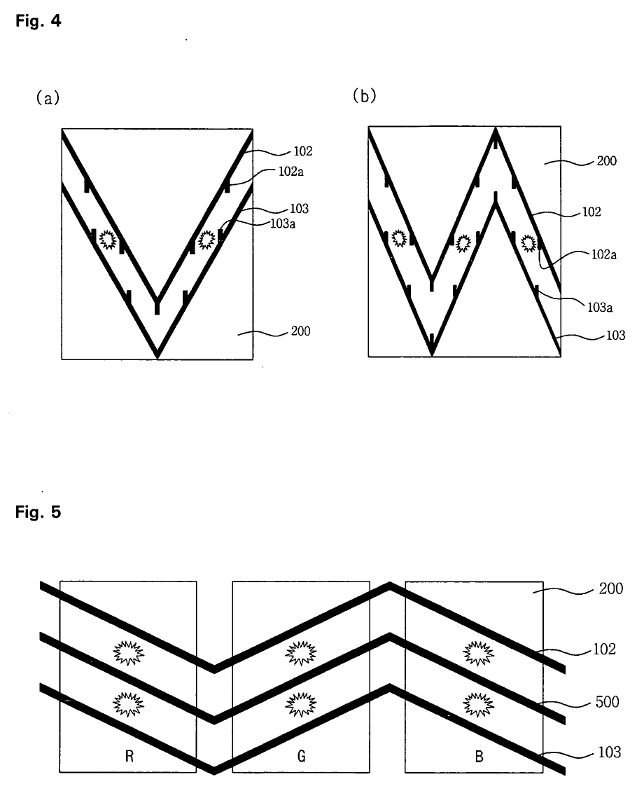

FIG. 4 illustrates bisymmetry of each of the first and second electrodes in one discharge cell as shown in FIG. 3.

As shown in FIG. 4A, the first and second electrodes 102 and 103 may be bisymmetry about the center of the discharge cell 200. As a result thereof, a discharge area can be expanded, so that the luminance is improved.

As shown in FIG. 4B, the first and second electrodes 102 and 103 may be also formed. Accordingly, the luminance can be improved more and more, comparing with that of FIG. 4A.

Until now, the first and second electrodes 102 and 103 formed in the oblique direction of the discharge cell 200 have been discussed. However, one or more electrodes may be further formed between the first electrode 102 and the second electrode 103. This will be explained with reference to FIG. 5.

FIG. 5 illustrates an instance where a center electrode is formed between the first electrode and the second electrode.

As shown in FIG. 5, the first electrode 102 is formed on a substrate in a first oblique line direction of each of the discharge cells 200, the second electrode 103 is formed on the substrate in a second oblique line direction of each of the discharge cells 200, and a center electrode 500 is formed between the first electrode 102 and the second electrode 103.

The first oblique line direction may be approximately the same as the second oblique line direction. As a result thereof, a discharge gap may be constantly maintained, and thus, the discharge characteristic produced from the discharge gap may be constantly maintained.

One of the scan electrode and the sustain electrode can function as the first and second electrodes 102 and 103, and the other can function as the center electrode 500.

For example, if the first and second electrodes 102 and 103 functions as the sustain electrode, the center electrode 500 can function as the scan electrode.

As a result thereof, the discharge gap is formed between the first electrode and the center electrode 500 and between the second electrode 103 and the center electrode 500, and a wide discharge area is formed in the discharge cell 200, thereby improving the luminance.

At least one of the first electrode 102, the second electrode 103, or the center electrode may be formed as a bus electrode in order to reduce manufacturing cost.

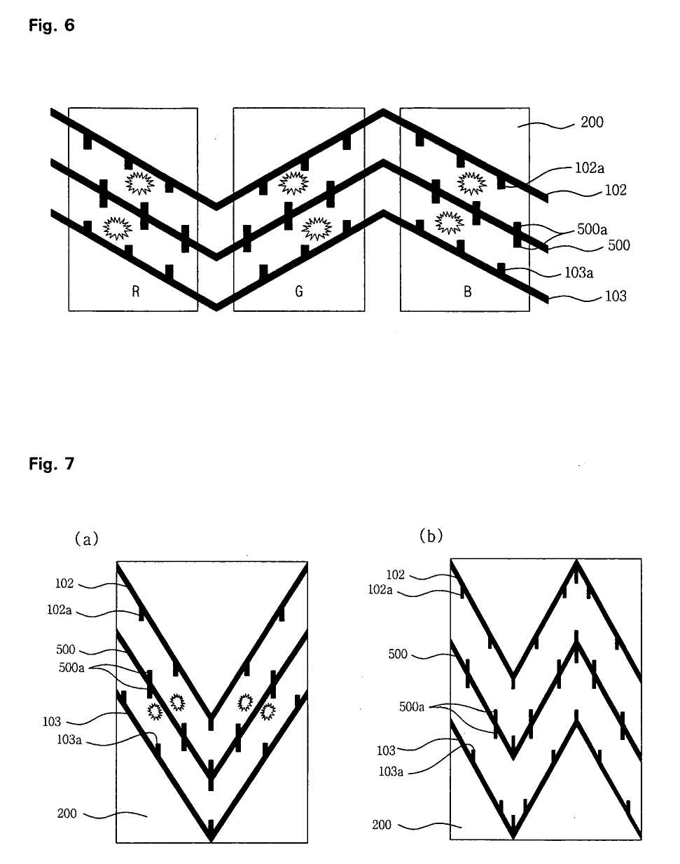

FIG. 6 illustrates an instance where a plurality of projection electrodes are formed on at least one of the first electrode, the second electrode or the center electrodes.

As shown in FIG. 6, at least one of the first, second or center electrode 102, 103 or 500 may include the plurality of projection electrodes 102a, 103a and 500a.

As a result thereof, the discharge area is increased more and more, and an initial discharge becomes easier, thereby improving the discharge effects.

The plurality of projection electrodes 102a and 103a included in at least one of the first or second electrodes 102 or 103 may be projected toward the center electrode 500 of the discharge cell 200, on which the discharge gap is formed.

The plurality of projection electrodes 500a included in the center electrode 500 may be projected toward at least one of the first or second electrodes 102 or 103 of the discharge cell 200 on which the discharge gap is formed.

As a result thereof, the projection electrodes are formed in a direction where the discharge gap is formed, and the initial discharge is effectively produced more and more.

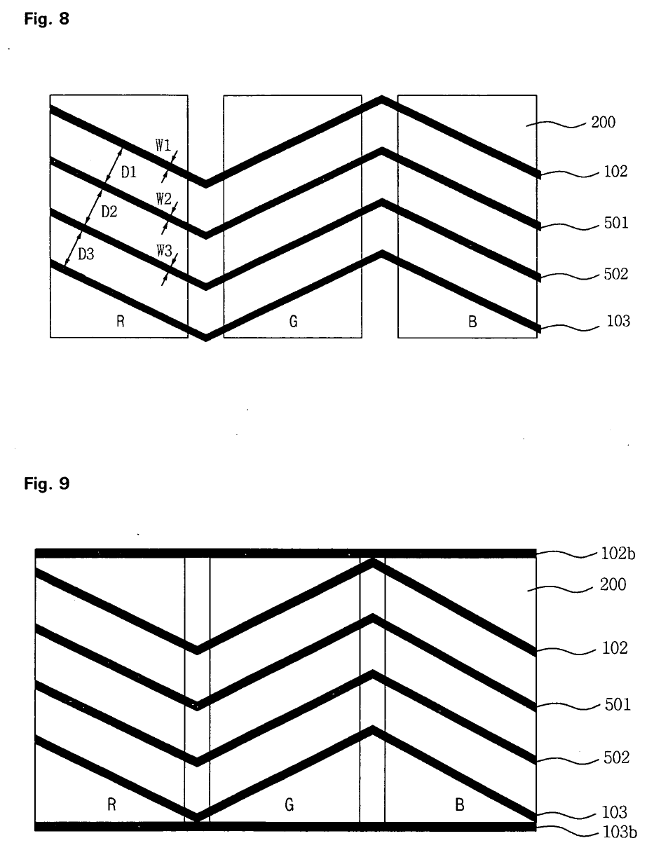

FIG. 7 illustrates bisymmetry of each of the first, second and center electrodes as shown in FIG. 6.

As shown in FIG. 7A, the first electrode 102, the second electrode 103, and the center electrode 500 may become bisymmetry about the center of the discharge cell 200. As a result thereof, the discharge area in the discharge cell 200 may be expanded more and more, and the discharge effect and luminance may be greatly improved.

In order to form a wider discharge area than that of FIG. 7A, the first electrode 102, the second electrode 130, and the center electrode 500 may be formed, as shown in FIG. 7B. As a result thereof, the luminance can be greatly improved.

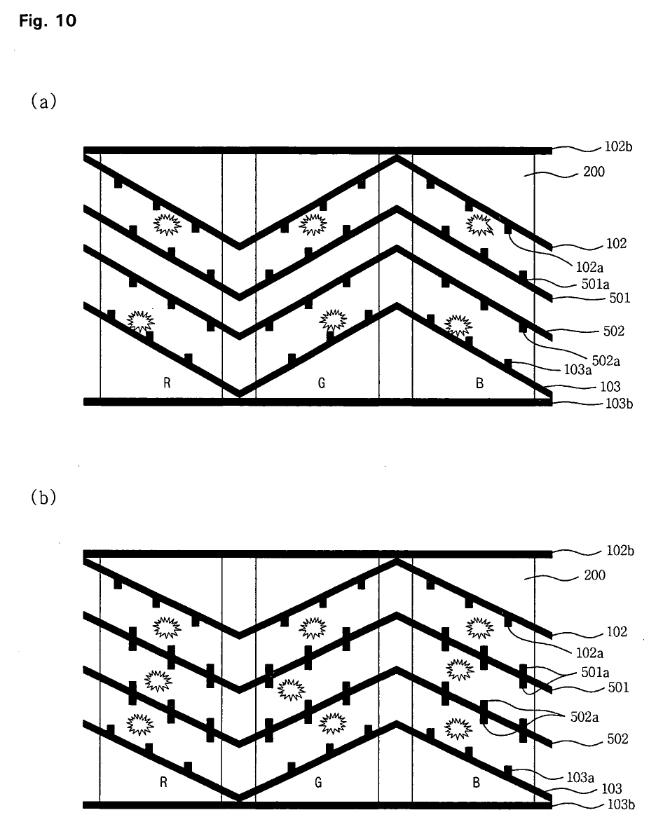

As described above, one electrode is formed of the first electrode 102, the second electrode 103, and the center electrode 500 formed between the first electrode 102 and the second electrode 13. However, the center electrode 500 may be divided into two. This will be explained with reference to FIG. 8.

FIG. 8 illustrates an instance where two center electrodes are formed between the first electrode and the second electrode.

As shown in FIG. 8, the first electrode 102 is formed on the substrate in the first oblique line direction of the discharge cell 200, the second electrode 103 is formed in the second oblique line direction of the discharge cell 200, a first center electrode 501 is formed closer to the first electrode 102 than the second electrode 103, and a second center electrode 502 is formed closer to the second electrode 103 than the first electrode 102.

At least one of the first and second electrodes 102 and 103 or the first and second center electrodes 501 and 502 may be formed as the bus electrode.

One of the scan electrode and the sustain electrode may be the first and second electrodes 102 and 103, and the other may be the first and second center electrodes 501 and 502.

For example, if the scan electrode functions as the first and second electrodes 102 and 103, the sustain electrode can function as the first and second center electrodes 501 and 502.

In this case, a discharge gap D1 is formed between the first electrode 102 and the first center electrode 501, and a discharge gap D3 is formed between the second electrode 103 and the second center electrode 502. The shortest distance D1 and D3 between the scan electrode and the sustain electrode may be 30 μm˜70 μm.

For example, if the shortest distance D1 and D3 is more than approximately 30 μm, the discharge gap may be prevented from being excessively narrow. Accordingly, a proper size of the discharge area is maintained within the discharge cell 200.

If the shortest distance D1 and D3 is less than approximately 70 μm, the discharge may be produced at a proper voltage level.

As another example, one of the scan electrode and the sustain electrode may be the first and second center electrodes 102 and 502, and the other may be the second electrode 103 and the first center electrode 501.

For example, if the scan electrode finctions as the first electrode 102 and the second center electrode 502, the sustain electrode may function as the second electrode 103 and the first center electrode 501.

In this case, the discharge gap D1, D2 and D3 are formed between the first electrode 102 and the first center electrode 501, between the first center electrode 501 and the second center electrode 502, and between the second electrode 103 and the second center electrode 502. Accordingly, the discharge area in the discharge cell is expanded, and thus the brightness may be improved. In this time, the shortest distances D1, D2 and D3 between the scan electrode and the sustain electrode may be 30 μm˜70 μm.

In other words, the shortest distances D1, D2 and D3 between the first electrode 102 and the first center electrode 501, between the first center electrode 501 and the second center electrode 502, and between the second electrode 103 and the second center electrode 502 may be 30 μm˜70 μm.

Section widths W1, W2 and W3 of at least one of the first electrode 102, the first center electrode 501, the second center electrode 502 or the second electrode 103 may be 20 μm˜60 μm.

If the section widths W1, W2 and W3 is more than 20 μm, an electric current can flow without being severely interrupted due to resistance caused by the electrodes 102, 103, 501 and 502, when an proper amount of current is applied to the electrodes 102, 103, 501 and 502.

If the section widths W1, W2 and W3 is less than 60 μm, an opening rate and luminance of the discharge cell 200 may be properly maintained by restricting the section widths W1, W2 and W3 of the electrodes 102, 103, 501 and 502.

FIG. 9 illustrates an instance where at least one of the first electrode or the second electrodes is formed in a direction perpendicular to an address electrode in each discharge cell.

As shown in FIG. 9, the first electrode 102 includes an electrode formed in a direction perpendicular to the address electrode 113, and the second electrode 103 may be formed in a direction perpendicular to the address electrode 113.

More particularly, the electrode formed in a direction perpendicular to the address electrode 113 may be formed in parallel with transverse barrier ribs between the discharge cells 200.

For example, if the barrier ribs of the discharge cell 200 are a wall-type or a stripe-type, the electrode formed in the direction perpendicular to the address electrode 113 may be included in at least one of the first and second electrodes 102 and 103.

The discharge cell 200 is formed as shown in FIG. 9, but the barrier ribs may be formed in a hexagon type. In this case, at least one of the first and second electrodes 102 and 103 may include an electrode formed in parallel with the transverse barrier rib of the discharge cell that is formed in a direction perpendicular to the address electrode 113.

In this time, if a discharge is produced between the first electrode 102 and the first center electrode 501, the discharge is produced in a direction perpendicular to the address electrode 113, and may be diffused in a direction of the electrode included in the first electrode 102. Accordingly, the discharge area is expanded, and thus, the brightness may be greatly improved.

Further, even when the discharge is produced between the second electrode 103 and the second electrode 502, the discharge may be diffused.

FIG. 10 illustrates an instance where a plurality of projection electrodes are formed on at least one of the first electrode, the second electrode, the first center electrode or the second center electrode.

As shown in FIGS. 10A and 10B, in one discharge cell 200, a plurality of projection electrodes 102a, 103a, 501a and 502a may be included in at least one of the first and second electrodes 102 and 103 or the first and second center electrodes 501 and 502. This makes it easier to produce the initial discharge in the discharge gap.

For example, as shown in FIG. 10A, if the first and second electrodes 102 and 103 function as the scan electrode, and the first and second center electrodes 501 and 502 function as the sustain electrode, the discharge gap is formed between the first electrode 102 and the first center electrode 501, and between the second electrode 103 and the second center electrode 502.

In this case, the plurality of projection electrodes 102a and 103a included in the first and second electrodes 102 and 103 may be projected toward the center electrodes 501 and 502 in order to easily produce the initial discharge.

The plurality of projection electrodes 501a and 502a, which are included in at least one of the first and second center electrodes 501 and 502, may be projected toward at least one of the first and second electrodes 102 and 103.

For example, as shown in FIG. 10A, if the discharge gap is formed between the first electrode 102 and the first center electrode 501, the plurality of projection electrodes 501a included in the first center electrode 501 may be formed toward the first electrode 102. If the discharge gap is formed between the second electrode 103 and the second center electrode 502, the plurality of projection electrodes 502a included in the second center electrode 502 may be formed toward the second electrode 102.

However, as shown in FIG. 10B, if the first and second center electrodes 102 and 502 function as the scan electrode, and the first center electrode 501 and the second center electrodes 103 function as the sustain electrode, the discharge gap is formed between the first electrode 102 and the first center electrode 501, between the first center electrode 501 and the second center electrode 502, and between the second center electrode 502 and the second electrode 103.

In this case, as shown in FIG. 10B, the plurality of projection electrodes 501a included in the first center electrode 501 may be formed toward the first electrode 102 and the second center electrode 502, and the plurality of projection electrodes 502a included in the second center electrode 502 may be formed toward the second electrode 103 and the first center electrode 501. As a result thereof, the number of the discharge gaps is increased, and thus, the discharge area is expanded, thereby allowing the luminance to be improved.

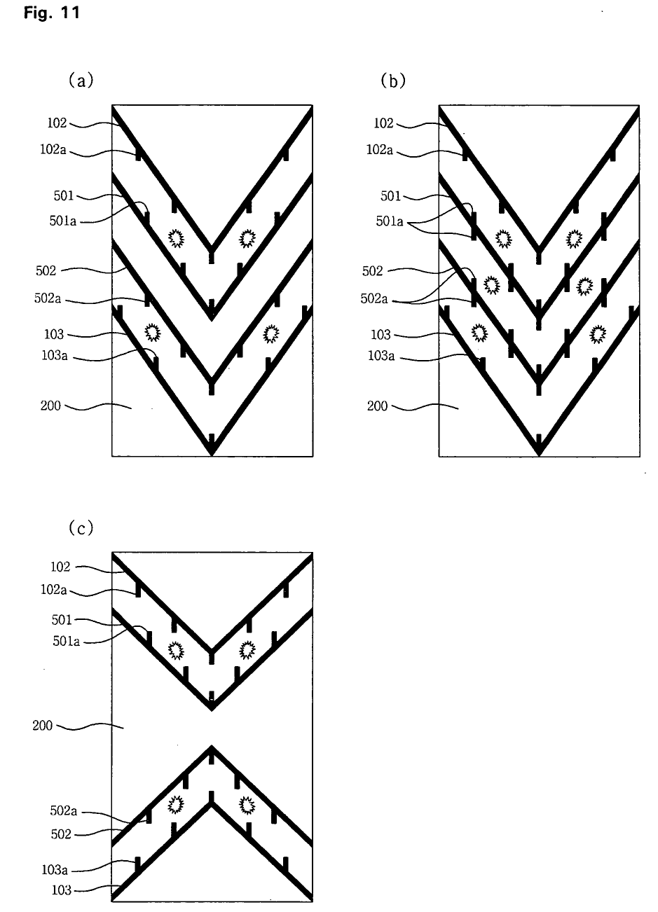

FIG. 11 illustrates an instance where the first and second electrodes and the first and second center electrodes are respectively left/right and up/down symmetry about the center of one discharge cell.

As shown in FIGS. 11A and 11B, if the first electrode 102 is formed in the discharge cell 200 in the first oblique line direction, the second electrode 103 is formed in the discharge cell 200 in the second oblique line direction, and the first and second center electrodes 501 and 502 are formed between the first electrode 102 and the second electrode 103, the first and second electrodes 102 and 103 and the first and second center electrodes 501 and 502 may be bisymmetry about the center of the discharge cell 200.

As shown in FIG. 11A, if one of the sustain electrode and the scan electrode functions as the first and second electrodes 102 and 103, and the other functions as the first and second center electrodes 501 and 502, the plurality of projection electrodes 102a and 103a included in the first and second electrodes 102 and 103 may be formed toward the first and second center electrodes 501 and 502, the projection electrode 501a of the first center electrode 501 may be formed toward the first electrode 102, and the projection electrode 502a of the second center electrode 502 may be formed toward the second electrode 103.

In this time, since the discharge gap is formed between the first electrode 102 and the first center electrode 501 and between the second electrode 103 and the second center electrode 502, distances between the first electrode 102 and the first center electrode 501 and between the second electrode 103 and the second center electrode 502 may be constantly maintained.

As shown in FIG. 11B, if one of the sustain electrode and the scan electrode functions as the first electrode 102 and the second center electrode 502, and the other functions as the second electrode 103 and the first center electrodes 501, the plurality of projection electrodes 102a and 103a included in the first and second electrodes 102 and 103 may be formed toward the first and second center electrodes 501 and 502, the projection electrode 501a of the first center electrode 501 may be formed toward the first electrode 102 and the second center electrode 502, and the projection electrode 502a of the second center electrode 502 may be formed toward the second electrode 103 and the first center electrode 501.

In this time, since the discharge gap is formed between the first electrode 102 and the first center electrode 501, between the first center electrode 501 and the second center electrode 502, and between the second center electrode 502 and the second electrode 103, distances between the first electrode 102 and the first center electrode 501, between the first center electrode 501 and the second center electrode 502, and between the second center electrode 502 and the second electrode 103 may be constantly maintained.

As shown in FIG. 11C, the first and second electrodes 102 and 103 and the first and second center electrodes 501 and 502 may be left-right and up-down symmetry about the center of the discharge cell 200.

In this time, since the first and second electrodes 102 and 103 is up-down symmetry about the discharge cell 200, the first oblique line direction of the first electrode is formed differently from the second oblique line direction of the second electrode, and the first oblique line direction of the first electrode 102 and the second oblique line direction of the second electrode 103 may be up-down symmetry about the center of the discharge cell 200.

The first and second electrodes 102 and 103 can function as the scan electrode, and the first and second center electrodes 501 and 502 can finction as the sustain electrode.

Therefore, since the discharge gap is formed between the first electrode 102 and the first center electrode 501 and between the second electrode 103 and the second center electrode 502, the distances between the first electrode 102 and the first center electrode 501 and between the second electrode 103 and the second center electrode 502 are approximately and constantly formed.

As a result, the sustain electrode and the scan electrode, which are formed in the oblique line direction within the discharge cell 200, may be formed in various shapes in order to expand the discharge area and improve the luminance.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel, comprising:
a substrate;
a first electrode formed on the substrate in a first oblique line direction of a discharge cell; and
a second electrode formed on the substrate in a second oblique line direction of a discharge cell.

2. The plasma display panel of claim 1, wherein the first electrode comprises either a scan electrode or a sustain electrode, and
the second electrode comprises either the scan electrode where the first electrode comprises the sustain electrode, or the sustain electrode where the first electrode comprises the scan electrode.

3. The plasma display panel of claim 1, wherein at least one of the first electrode or the second electrode comprises a bus electrode.

4. The plasma display panel of claim 1, wherein at least one of the first electrode or the second electrode comprises a plurality of projection electrodes.

5. The plasma display panel of claim 4, wherein the plurality of projection electrodes of the first electrode is projected toward the second electrode direction, and the plurality of projection electrodes of the second electrode direction is projected toward the first electrode.

6. The plasma display panel of claim 1, wherein the first oblique line direction is approximately the same as the second oblique line direction.

7. The plasma display panel of claim 1, wherein the first and second electrodes are located within the discharge cell such that the first and second electrodes are bilaterally symmetrical to each other about the center of the discharge cell.

8. A plasma display panel, comprising:
a substrate;
a first electrode formed on the substrate in a first oblique line direction of a discharge cell;
a second electrode formed on the substrate in a second oblique line direction of the discharge cell; and
a center electrode formed between the first electrode and the second electrode.

9. The plasma display panel of claim 8, wherein the first electrode and the second electrode comprise either a scan electrode or a sustain electrode, and
the center electrode comprises either the scan electrode where the first electrode and the second electrode comprise the sustain electrode, or the sustain electrode where the first electrode and the second electrode comprise the scan electrode.

10. The plasma display panel of claim 8, wherein at least one of the first electrode, the second electrode or the center electrode comprises a bus electrode.

11. The plasma display panel of claim 8, wherein at least one of the first electrode, the second electrode or the center electrode comprises a plurality of projection electrodes.

12. The plasma display panel of claim 11, wherein the plurality of projection electrodes of at least one of the first electrode or the second electrode are projected toward the center electrode of the discharge cell.

13. The plasma display panel of claim 11, wherein the plurality of projection electrodes of the center electrode is projected toward at least one of the first electrode or the second electrode.

14. The plasma display panel of claim 8, wherein the first oblique line direction is approximately the same as the second oblique line direction.

15. The plasma display panel of claim 8, wherein the first, second and center electrodes are located within the discharge cell such that the first, second and center electrodes are bilaterally symmetrical to each other about the center of the discharge cell.

16. A plasma display panel, comprising:
a substrate;
a first electrode formed on the substrate in a first oblique line direction of a discharge cell;
a second electrode formed on the substrate in a second oblique line direction of the discharge cell;
a first center electrode formed closer to the first electrode than the second electrode; and
a second center electrode formed closer to the second electrode than the first electrode.

17. The plasma display panel of claim 16, wherein at least one of the first electrode or the second electrode comprises an electrode formed in a direction perpendicular to an address electrode.

18. The plasma display panel of claim 16, wherein the electrode formed in the direction perpendicular to the address electrode is in parallel with transverse barrier ribs between the discharge cells.

19. The plasma display panel of claim 16, wherein at least one of the first electrode, the second electrode, the first center electrode or the second center electrode comprises a bus electrode.

20. The plasma display panel of claim 16, wherein at least one of the first electrode, the second electrode, the first center electrode or the second center electrode comprise a plurality of projection electrodes.

21. The plasma display panel of claim 20, wherein the plurality of projection electrodes of at least one of the first electrode or the second electrodes is projected toward the center electrode.

22. The plasma display panel of claim 20, wherein the plurality of projection electrodes of the first and second center electrodes is projected toward at least one of the first electrode or the second electrode.

23. The plasma display panel of claim 16, wherein the first oblique line direction is different from the second oblique direction.

24. The plasma display panel of claim 16, wherein the first and second electrodes and the first and second center electrodes are left-right or up-down symmetry about the center of each discharge cell.

25. The plasma display panel of claim 16, wherein the first electrode and the second electrode comprise either a scan electrode or a sustain electrode, and
the first center electrode and the second center electrode comprise either the scan electrode where the first electrode and the second electrode comprise the sustain electrode, or the sustain electrode where the first electrode and the second electrode comprise the scan electrode.

26. The plasma display panel of claim 25, wherein the shortest distance between the scan electrode and the sustain electrode ranges from 30 μm to 70 μm.

27. The plasma display panel of claim 16, wherein the first electrode and the second center electrode comprise either a scan electrode or a sustain electrode, and
the first center electrode and the second electrode comprise either the scan electrode where the first electrode and the second center electrode comprise the sustain electrode, or the sustain electrode where the first electrode and the second center electrode comprise the scan electrode.

28. The plasma display panel of claim 27, wherein the shortest distance between the scan electrode and the sustain electrode ranges from 30 μm to 70 μm.

29. The plasma display panel of claim 16, wherein a section width of at least one of the first electrode, the second electrode, the first center electrode or the second center electrode ranges from 20 μm to 60 μm.
